(19) United States
(12) Patent Application Publication
(10) Pub. No.: US 2023/0159751 A1
(43) Pub. Date: May 25, 2023

(54) Polymer Composition For Waterproof-Breathable Films

(71) Applicant: ARKEMA FRANCE, Colombes (FR)

(72) Inventors: Clio COCQUET, Serquigny (FR); Sébastien CALLOUET, Serquigny (FR); Laurent CARTIER, Bristol, PA (US)

(73) Assignee: ARKEMA FRANCE, Colombes (FR)

(21) Appl. No.: 17/995,622

(22) PCT Filed: Apr. 7, 2021
(86) PCT No.: PCT/FR2021/050606

§ 371 Date: Oct. 6, 2022

(30) Foreign Application Priority Data
Apr. 7, 2020 (FR) 2003471

(51) Int. Cl. C08L 77/02; C08G 69/40

(52) U.S. Cl. CPC C08L 77/02; C08G 69/40; C08L 2203/16

(57) ABSTRACT

A composition of: 75 to 98% by weight, relative to the weight of the composition, of at least one copolymer A containing polyamide blocks and polyether blocks; 2 to 15% by weight, relative to the weight of the composition, of at least one copolymer B including units derived from ethylene, from an alkyl (meth)acrylate and from a comonomer including at least one acid, anhydride or epoxide function; and 0 to 10% by weight, relative to the weight of the composition, of at least one additive. The polyether blocks of copolymer A include polyethylene glycol blocks. Further, a process for manufacturing a film and to said film.

### FIELD OF THE INVENTION

The present invention relates to a polymer composition and also to a waterproof-breathable film obtained using said composition.

### TECHNICAL BACKGROUND

Films that are impermeable to liquid water and permeable to water vapor are used in various fields such as textiles, construction, agriculture, packaging, etc. These films may be used, for example, as packagings for covering articles or as coatings adhered to the surface of articles.

In general, breathable films must meet certain requirements such as a homogeneous appearance, wind resistance, high permeability to water vapor, a certain elasticity, as well as a capacity for adhering to different substrates. In addition, these films must be readily processable during production, notably by extrusion, without causing deformations in the film. Poor processability is reflected by imperfections on the films, such as holes or irregular edges.

It is known practice to use compositions comprising containing polyamide blocks and polyether blocks in order to form such films. However, despite a high permeability to water vapor, the films formed are sparingly stretchable, which causes problems during their manufacture by extrusion, notably by extrusion coating.

Moreover, the use of terpolymer compositions, notably terpolymers derived from ethylenic, acrylic and butylenic monomers, makes it possible to obtain films that can be readily processable by extrusion. However, these films have very low breathability.

US 2004/0 029 467 relates to a breathable film which comprises at least one polymer (a) chosen from the group comprising an ethylene/alkyl (meth)acrylate copolymer (a1), an optionally neutralized ethylene/(meth)acrylic acid copolymer (a2), an ethylene/vinyl monomer copolymer (a3), the mixture (a1)/(a2), the mixture (a1)/(a3), the mixture (a2)/(a3) and the mixture (a1)/(a2)/(a3), and/or which comprises at least one functionalized polyethylene (b); and at least one copolymer (c) containing copolyamide blocks or polyester blocks and polyether blocks.

U.S. Pat. No. 5,614,588 relates to a polymer blend comprising a polyether block amide consisting of 30% to 60% by weight of polyamide-12, polyamide-11 and/or polyamide-12,12 blocks and 70% to 40% by weight of polyethylene glycol blocks, a polyether block amide consisting of 65% to 85% by weight of polyamide-12, polyamide-11 and/or polyamide-12,12 blocks and 35% to 15% by weight of polyethylene glycol blocks, and a poly(ethylene-co-vinyl acetate-g-maleic anhydride) polymer consisting of 75% to 95% by weight of ethylene, 5% to 25% by weight of vinyl acetate and 0.1% to 2% by weight of maleic anhydride. The composition of said document is used for manufacturing films that are permeable to water vapor.

U.S. Pat. No. 5,506,024 relates to films that are permeable to water vapor manufactured from thermoplastic elastomers based on polyetheresteramide and preferably based on polyether block amide.

U.S. Pat. No. 5,800,928 relates to films that are permeable to water vapor comprising at least one thermoplastic elastomer comprising polyether blocks and at least one copolymer comprising ethylene and at least one alkyl (meth)acrylate.

There is a need to provide a composition that allows the manufacture of films which have both good permeability to water vapor and good processability during their manufacture.

### SUMMARY OF THE INVENTION

The invention relates firstly to a composition consisting of:
from 75% to 98% by weight of at least one copolymer A containing polyamide blocks and polyether blocks, relative to the weight of the composition;
from 2% to 15% by weight of at least one copolymer B comprising units derived from ethylene, from an alkyl (meth)acrylate and from a comonomer including at least one acid, anhydride or epoxide function, relative to the weight of the composition; and
from 0 to 10% by weight of at least one additive, relative to the weight of the composition,

in which the polyether blocks of copolymer A comprise polyethylene glycol blocks.

According to certain embodiments, the polyamide blocks of copolymer A are blocks of polyamide 11, or of polyamide 12, or of polyamide 6, or of polyamide 10.10, or of polyamide 10.12, or of polyamide 6.10, and also combinations thereof.

According to certain embodiments, the alkyl (meth)acrylate includes an alkyl group comprising from 1 to 24 carbon atoms, and preferably from 1 to 5 carbon atoms.

According to certain embodiments, the alkyl (meth)acrylate is chosen from methyl (meth)acrylate, ethyl (meth)acrylate, and butyl (meth)acrylate and also combinations thereof.

According to certain embodiments, the molar content of units derived from alkyl (meth)acrylate in copolymer B is from 5% to 35%.

According to certain embodiments, the molar content of comonomer including at least one acid, anhydride or epoxide function in copolymer B is from 0.1% to 15%.

According to certain embodiments, the comonomer including at least one acid, anhydride or epoxide function is chosen from unsaturated carboxylic acid anhydrides, and preferably is maleic anhydride.

According to certain embodiments, the comonomer including at least one acid, anhydride, or epoxide function has an unsaturated epoxide function, and preferably is glycidyl methacrylate.

According to certain embodiments, copolymer B is free of units derived from vinyl acetate.

According to certain embodiments, the additive is chosen from inert dyes such as titanium dioxide, fillers, surfactants, crosslinking agents, nucleating agents, reactive compounds, mineral or organic flame retardants, ultraviolet (UV) or infrared (IR) light absorbers, UV or IR fluorescent agents, and also combinations thereof.

The invention also relates to a process for manufacturing a film using the composition described above.

The film according to the invention may be prepared via any method that makes it possible to obtain an intimate or homogeneous mixture containing said copolymer A and a copolymer B according to the invention, and optionally one or more additives, such as melt compounding, extrusion, compacting or else a roll mill.

According to one embodiment, a step of dry blending of copolymer A and copolymer B in the form of granules is applied (“dry blending”).

The usual mixing and kneading devices of the thermoplastics industry, such as extruders, twin-screw extruders, notably self-cleaning gearing co-rotating twin-screw extruders, and kneading machines, for example Buss co-kneaders or internal mixers, are advantageously used.

According to a preferential embodiment, the process for manufacturing the film is an extrusion process. According to certain embodiments, the extrusion is performed at a temperature of from 100 to 300° C., and preferably from 150 to 250° C.

The process generally comprises a step of drawing the composition. The drawing step may be performed by extrusion blow-molding.

According to one embodiment, the drawing step is performed by extrusion coating.

According to one embodiment, the drawing step is performed by flat extrusion.

The invention also relates to a film obtained via the processes described above.

The present invention makes it possible to overcome the drawbacks of the prior art. More particularly, it provides a composition that allows the manufacture of films having both good permeability to water vapor and good processability during their manufacture.

This is accomplished by means of a composition consisting of at least one copolymer A containing polyamide blocks and polyether blocks and at least one copolymer B comprising units derived from at least three comonomers: a first ethylene comonomer, a second alkyl (meth)acrylate comonomer, and a third comonomer including at least one reactive function in the form of an acid, anhydride, or epoxide group; and optionally one or more additives. More particularly, this composition consisting of from 75% to 98% by weight of copolymer A, from 2% to 15% by weight of copolymer B and from 0 to 10% of at least one additive, makes it possible to obtain films having good permeability to water vapor and very good processability, notably by extrusion, and in particular by hot extrusion.

### DESCRIPTION OF EMBODIMENTS OF THE INVENTION

The invention is now described in greater detail and in a nonlimiting manner in the description that follows.

Composition

The composition according to the invention consists of:
at least one copolymer A containing polyamide blocks and polyether blocks;
at least one copolymer B comprising units derived from at least three comonomers: a first ethylene comonomer, a second alkyl (meth)acrylate comonomer and a third comonomer comprising at least one reactive function in the form of an acid, anhydride or epoxide group; and
optionally at least one additive.

As regards the copolymers A containing polyamide blocks and polyether blocks (abbreviated as “PEBA”), they result from the polycondensation of polyamide blocks bearing reactive ends with polyether blocks bearing reactive ends, such as, inter alia:

1) polyamide blocks bearing diamine chain ends with polyoxyalkylene blocks bearing dicarboxylic chain ends;

2) polyamide blocks bearing dicarboxylic chain ends with polyoxyalkylene blocks bearing diamine chain ends, obtained, for example, by cyanoethylation and hydrogenation of α,ω-dihydroxylated aliphatic polyoxyalkylene blocks, known as polyetherdiols;

3) polyamide blocks bearing dicarboxylic chain ends with polyetherdiols, the products obtained being, in this particular case, polyetheresteramides.

The polyamide blocks bearing dicarboxylic chain ends originate, for example, from the condensation of polyamide precursors in the presence of a chain-limiting dicarboxylic acid. The polyamide blocks bearing diamine chain ends originate, for example, from the condensation of polyamide precursors in the presence of a chain-limiting diamine.

The polymers bearing polyamide blocks and polyether blocks may also comprise randomly distributed units.

Three types of polyamide blocks may advantageously be used.

According to a first type, the polyamide blocks originate from the condensation of a dicarboxylic acid, in particular those containing from 4 to 20 carbon atoms, preferably those containing from 6 to 18 carbon atoms, and of an aliphatic or aromatic diamine, in particular those containing from 2 to 20 carbon atoms, preferably those containing from 6 to 14 carbon atoms.

As examples of dicarboxylic acids, mention may be made of 1,4-cyclohexanedicarboxylic acid, butanedioic acid, adipic acid, azelaic acid, suberic acid, sebacic acid, dodecanedicarboxylic acid, octadecanedicarboxylic acid, terephthalic acid and isophthalic acid, but also dimerized fatty acids.

As examples of diamines, mention may be made of tetramethylenediamine, hexamethylenediamine, 1,10-decamethylenediamine, dodecamethylenediamine, trimethylhexamethylenediamine, the isomers of bis(4-aminocyclohexyl)methane (BACM), bis(3-methyl-4-aminocyclohexyl)methane (BMACM) and 2-2-bis-(3-methyl-4-aminocyclohexyl)propane (BMACP), and para-aminodicyclohexylmethane (PACM), and isophoronediamine (IPDA), 2,6-bis(aminomethyl)norbornane (BAMN) and piperazine (Pip).

Advantageously, PA 4.12, PA 4.14, PA 4.18, PA 6.10, PA 6.12, PA 6.14, PA 6.18, PA 9.12, PA 10.10, PA 10.12, PA 10.14 and PA 10.18 blocks are used. In the notation PA X.Y, X represents the number of carbon atoms derived from the diamine residues and Y represents the number of carbon atoms derived from the diacid residues, as is conventional.

According to a second type, the polyamide blocks result from the condensation of one or more α,ω-aminocarboxylic acids and/or from one or more lactams containing from 6 to 12 carbon atoms in the presence of a dicarboxylic acid containing from 4 to 12 carbon atoms or of a diamine. As examples of lactams, mention may be made of caprolactam, oenantholactam and lauryllactam. As examples of α,ω-aminocarboxylic acids, mention may be made of aminocaproic acid, 7-aminoheptanoic acid, 11-aminoundecanoic acid and 12-aminododecanoic acid.

Advantageously, the polyamide blocks of the second type are made of polyamide 11, polyamide 12 or polyamide 6. In the notation PA X, X represents the number of carbon atoms derived from amino acid residues.

According to a third type, the polyamide blocks result from the condensation of at least one α,ω-aminocarboxylic acid (or a lactam), at least one diamine and at least one dicarboxylic acid.

In this case, the polyamide PA blocks are prepared by polycondensation:
of the linear aliphatic or aromatic diamine(s) containing X carbon atoms;
of the dicarboxylic acid(s) containing Y carbon atoms; and
of the comonomer(s) {Z}, chosen from lactams and α,ω-aminocarboxylic acids containing Z carbon atoms and equimolar mixtures of at least one diamine containing X1 carbon atoms and of at least one dicarboxylic acid containing Y1 carbon atoms, (X1, Y1) being different from (X, Y),
said comonomer(s) {Z} being introduced in a weight proportion ranging up to 50%, preferably up to 20%, even more advantageously up to 10% relative to the total amount of polyamide-precursor monomers;
in the presence of a chain limiter chosen from dicarboxylic acids;

advantageously, the dicarboxylic acid containing Y carbon atoms is used as chain limiter, which is introduced in excess relative to the stoichiometry of the diamine(s).

According to one variant of this third type, the polyamide blocks result from the condensation of at least two α,ω-aminocarboxylic acids or of at least two lactams containing from 6 to 12 carbon atoms or of one lactam and one aminocarboxylic acid not having the same number of carbon atoms, in the optional presence of a chain limiter. As examples of aliphatic α,ω-aminocarboxylic acids, mention may be made of aminocaproic acid, 7-aminoheptanoic acid, 11-aminoundecanoic acid and 12-aminododecanoic acid. As examples of lactams, mention may be made of caprolactam, oenantholactam and lauryllactam. As examples of aliphatic diamines, mention may be made of hexamethylenediamine, dodecamethylenediamine and trimethylhexamethylenediamine. As examples of cycloaliphatic diacids, mention may be made of 1,4-cyclohexanedicarboxylic acid. As examples of aliphatic diacids, mention may be made of butanedioic acid, adipic acid, azelaic acid, suberic acid, sebacic acid, dodecanedicarboxylic acid, dimerized fatty acids (these dimerized fatty acids preferably have a dimer content of at least 98%; they are preferably hydrogenated; they are sold under the brand name Pripol by the company Unichema, or under the brand name Empol by the company Henkel) and α,ω-diacid polyoxyalkylenes. As examples of aromatic diacids, mention may be made of terephthalic acid (T) and isophthalic acid (I). As examples of cycloaliphatic diamines, mention may be made of the isomers of bis(4-aminocyclohexyl)methane (BACM), bis(3-methyl-4-aminocyclohexyl)methane (BMACM) and 2,2-bis(3-methyl-4-aminocyclohexyl)propane (BMACP), and para-aminodicyclohexylmethane (PACM). The other diamines commonly used may be isophoronediamine (IPDA), 2,6-bis(aminomethyl)norbornane (BAMN) and piperazine.

As examples of polyamide blocks of the third type, mention may be made of the following:
PA 6.6/6, in which 6.6 denotes hexamethylenediamine units condensed with adipic acid and 6 denotes units resulting from the condensation of caprolactam;
PA 6.6/6.10/11/12 in which 6.6 denotes hexamethylenediamine condensed with adipic acid; 6.10 denotes hexamethylenediamine condensed with sebacic acid; 11 denotes units resulting from the condensation of aminoundecanoic acid; and 12 denotes units resulting from the condensation of lauryllactam.

The notations PA X/Y, PA X/Y/Z, etc. relate to copolyamides in which X, Y, Z, etc. represent homopolyamide units as described above.

Advantageously, said at least one polyamide block of the copolymer(s) used in the composition of the invention comprises at least one of the following polyamide monomers: 6, 11, 12, 5.4, 5.9, 5.10, 5.12, 5.13, 5.14, 5.16, 5.18, 5.36, 6.4, 6.9, 6.10, 6.12, 6.13, 6.14, 6.16, 6.18, 6.36, 10.4, 10.9, 10.10, 10.12, 10.13, 10.14, 10.16, 10.18, 10.36, 10. T, 12.4, 12.9, 12.10, 12.12, 12.13, 12.14, 12.16, 12.18, 12.36, 12.T and mixtures or copolymers thereof; and preferably chosen from the following polyamide monomers: 6, 11, 12, 6.10, 10.10, 10.12, and mixtures or copolymers thereof.

Preferably, the polyamide blocks comprise at least 30%, preferably at least 50%, preferably at least 75%, preferably 100%, by weight of PA6, PA 11 or PA 12, relative to the total weight of polyamide blocks.

The polyether blocks may represent 50% to 80% by weight of the copolymer bearing polyamide and polyether blocks.

The polyether blocks may notably be blocks derived from PEG (polyethylene glycol), i.e. blocks formed from ethylene oxide units, and/or blocks derived from PPG (propylene glycol), i.e. blocks formed from propylene oxide units, and/or blocks derived from PO3G (polytrimethylene glycol), i.e. blocks formed from polytrimethylene glycol ether units. The polyether blocks may also comprise blocks derived from PTMG, i.e. blocks formed from tetramethylene glycol units, also called polytetrahydrofuran. The PEBA copolymers may comprise in their chain several types of polyethers, the copolyethers possibly being in block or statistical form.

In the context of the present invention, the PEBA copolymer comprises PEG blocks, optionally combined with PPG blocks, PO3G blocks, and/or PTMG blocks.

Thus, according to certain embodiments, the PEBA copolymer comprises PEG blocks. These blocks may be present in the PEBA copolymer in a content of from 40% to 80%, preferably from 40% to 75%, and even more preferably from 40% to 60% by weight relative to the weight of the copolymer. For example, this content may be from 40% to 45%; or from 45% to 50%; or from 50% to 55%; or from 55% to 60%; or from 60% to 65%; or from 65% to 70%; or from 70% to 75%; or from 75% to 80% by weight relative to the weight of the copolymer.

Preferably, the polyether blocks comprise at least 30%, preferably at least 50%, preferably at least 75%, preferably 100%, by weight of PEG blocks relative to the total weight of polyether blocks.

According to one embodiment, the PEBA copolymer of the composition may also comprise at least one polyether other than PEG, chosen from PTMG, PPG, PO3G, and mixtures thereof.

Use may also be made of blocks obtained by oxyethylation of bisphenols, for instance bisphenol A. The latter products are described in patent EP613919.

The polyether blocks may also consist of ethoxylated primary amines. As examples of ethoxylated primary amines, mention may be made of the products of formula:

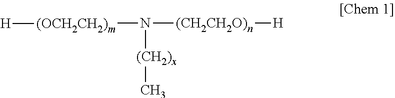

in which m and n are between 1 and 20, and xis between 8 and 18. These products are commercially available under the brand name Noramox® from the company Arkema and under the brand name Genamin® from the company Clariant.

The flexible polyether blocks may comprise polyoxyalkylene blocks bearing NH₂ chain ends, such blocks being able to be obtained by cyanoacetylation of α,ω-dihydroxylated aliphatic polyoxyalkylene blocks referred to as polyetherdiols. More particularly, use may be made of the Jeffamine products (for example Jeffamine® D400, D2000, ED 2003, XTJ 542, which are commercial products from the company Huntsman, also described in patents JP2004346274, JP2004352794 and EP1482011).

The polyether diol blocks are either used in unmodified form and copolycondensed with polyamide blocks bearing carboxylic end groups, or they are aminated to be converted into polyetherdiamines and condensed with polyamide blocks bearing carboxylic end groups. The general method for the two-step preparation of PEBA copolymers containing ester bonds between the PA blocks and the PE blocks is known and is described, for example, in French patent FR 2846332. The general method for the preparation of the PEBA copolymers of the invention containing amide bonds between the PA blocks and the PE blocks is known and is described, for example, in European patent EP 1 482 011. The polyether blocks may also be mixed with polyamide precursors and a chain-limiting diacid to prepare polymers containing polyamide blocks and polyether blocks having randomly distributed units (one-step process).

Needless to say, the name PEBA in the present description of the invention relates not only to the Pebax® products sold by Arkema, to the Vestamid® products sold by Evonik® and to the Grilamid® products sold by EMS, but also to the Pelestat® type PEBA products sold by Sanyo or to any other PEBA from other suppliers.

Advantageously, the PEBA copolymers may contain polyamide blocks as PA 6, as PA 11, as PA 12, PA 6.10, PA 6.12, as PA 6.6/6, as PA 10.10 and/or as PA 6.14, preferably PA 11 and/or PA 12 blocks; and polyether blocks as PEG.

PEBA copolymers that are particularly preferred in the context of the invention are copolymers including blocks from among:
PA 11 and derived from PEG;
PA 12 and derived from PEG;
PA 6.10 and derived from PEG;
PA 10.10 and derived from PEG;
PA 10.12 and derived from PEG;
PA 6.12 and derived from PEG;
PA 6 and derived from PEG.

If the block copolymers described above generally comprise at least one polyamide block and at least one polyether block, the present invention also covers all the copolymers comprising two, three, four (or even more) different blocks chosen from those described in the present description, provided that these blocks include at least polyamide and polyether blocks.

Advantageously, the copolymer alloy according to the invention comprises a block segmented copolymer comprising three different types of blocks (referred to as “triblock” in the present description of the invention), which result from the condensation of several of the blocks described above. Said triblock is preferably chosen from copolyetheresteramides, copolyetheramideurethanes, in which:
the mass percentage of polyamide blocks is greater than 10%;
the mass percentage of PEG blocks is greater than 50%;
   relative to the total mass of triblock.

The number-average molar mass of the polyamide blocks in the PEBA copolymer is preferably from 400 to 20 000 g/mol, more preferentially from 500 to 10 000 g/mol and even more preferentially from 200 to 2000 g/mol. In certain embodiments, the number-average molar mass of the polyamide blocks in the PEBA copolymer is from 400 to 1000 g/mol, or from 1000 to 1500 g/mol, or from 1500 to 2000 g/mol, or 2000 to 2500 g/mol, or 2500 to 3000 g/mol, or 3000 to 3500 g/mol, or 3500 to 4000 g/mol, or 4000 to 5000 g/mol, or from 5000 to 6000 g/mol, or from 6000 to 7000 g/mol, or from 7000 to 8000 g/mol, or from 8000 to 9000 g/mol, or from 9000 to 10 000 g/mol, or from 10 000 to 11 000 g/mol, or from 11 000 to 12 000 g/mol, or from 12 000 to 13 000 g/mol, or from 13 000 to 14 000 g/mol, or from 14 000 to 15 000 g/mol, or from 15 000 to 16 000 g/mol, or from 16 000 to 17 000 g/mol, or from 17 000 to 18 000 g/mol, or from 18 000 to 19 000 g/mol, or from 19 000 to 20 000 g/mol.

The number-average molar mass of the polyether blocks is preferably from 100 to 6000 g/mol, more preferentially from 200 to 3000 g/mol. In certain embodiments, the number-average molar mass of the polyether blocks is from 100 to 200 g/mol, or from 200 to 500 g/mol, or from 500 to 800 g/mol, or from 800 to 1000 g/mol, or from 1000 to 1500 g/mol, or from 1500 to 2000 g/mol, or from 2000 to 2500 g/mol, or from 2500 to 3000 g/mol, or from 3000 to 3500 g/mol, or from 3500 to 4000 g/mol, or from 4000 to 4500 g/mol, or from 4500 to 5000 g/mol, or from 5000 to 5500 g/mol, or from 5500 to 6000 g/mol.

The number-average molar mass is set by the content of chain limiter. It may be calculated according to the equation:

Mₙ=nₘₒₙₒₘₑᵣ×MW_{repeating unit}/n_{chain limiter}+MW_{chain limiter}

In this formula, nₘₒₙₒₘₑᵣ represents the number of moles of monomer, n_{chain limiter} represents the number of moles of limiter (for example diacid) in excess, MW_{repeating} unit represents the molar mass of the repeating unit, and MW_{chain} limiter represents the molar mass of the limiter (for example diacid) in excess.

The number-average molar mass of the polyamide blocks and of the polyether blocks may be measured before the copolymerization of the blocks by gel permeation chromatography (GPC).

The mass ratio of the polyamide blocks relative to the polyether blocks of the PEBA copolymer may notably be from 0.1 to 20. This mass ratio may be calculated by dividing the number-average molar mass of the polyamide blocks by the number-average molar mass of the polyether blocks.

Thus, the mass ratio of the polyamide blocks relative to the polyether blocks of the PEBA copolymer may be from 0.1 to 0.2; or from 0.2 to 0.3; or from 0.3 to 0.4; or from 0.4 to 0.5; or from 0.5 to 1; or from 1 to 2; or from 2 to 3; or from 3 to 4; or from 4 to 5; or from 5 to 7; or from 7 to 10; or from 10 to 13; or from 13 to 16; or from 16 to 19; or from 19 to 20.

Ranges from 2 to 19 and more specifically from 4 to 10 are particularly preferred.

The PEBA copolymer is present in the composition in a content ranging from 75% to 98% and preferably from 75% to 95% by weight relative to the weight of the composition. For example, the PEBA copolymer may be present in the composition in a content of from 75% to 78%; or from 78% to 80%; or from 80% to 82%; or from 82% to 84%; or from 84% to 86%; or from 86% to 88%; or from 88% to 90%; or from 90% to 92%; or from 92% to 94%; or from 94% to 96%; or from 96% to 98% by weight relative to the weight of the composition

As regards copolymer B comprising units derived from at least three comonomers, it is present in a content of from 2% to 15%, and preferably from 5% to 15% by weight relative to the weight of the composition. For example, this copolymer B may be present in the composition in a content of from 2% to 3%; or from 3% to 4%; or from 4% to 5%; or from 5% to 6%; or from 6% to 7%; or from 7% to 8%; or from 8% to 9%; or from 9% to 10%; or from 10% to 11%; or from 11% to 12%; or from 12% to 13%; or from 13% to 14%; or from 14% to 15% by weight relative to the weight of the composition.

The first comonomer from which this copolymer B is manufactured is ethylene. The units derived from ethylene may have a molar content in copolymer B of from 50% to 94.9%, and preferably from 58% to 79%. This molar content may notably be from 50% to 55%; or from 55% to 60%; or from 60% to 65%; or from 65% to 70%; or from 70% to 75%; or from 75% to 80%; or from 80% to 85%; or from 85% to 90%; or from 90% to 94.9%.

The second comonomer from which this copolymer B is manufactured is an alkyl (meth)acrylate. The term “alkyl (meth)acrylate” refers to alkyl acrylates and alkyl methacrylates. Preferably, the alkyl group of the alkyl (meth)acrylate comprises from 1 to 24 carbon atoms and preferably from 1 to 5 carbon atoms. For example, it may comprise from 1 to 2; or from 2 to 4; or from 4 to 6; or from 6 to 8; or from 8 to 10; or from 10 to 12; or from 12 to 14; or from 14 to 16; or from 16 to 18; or from 18 to 20; or from 20 to 22; or from 22 to 24 carbon atoms.

According to certain preferred embodiments, the second comonomer is chosen from methyl (meth)acrylate, ethyl (meth)acrylate, butyl (meth)acrylate, isobutyl (meth)acrylate, 2-ethylhexyl (meth)acrylate, and also combinations thereof. Preferably, the second comonomer is chosen from methyl (meth)acrylate, ethyl (meth)acrylate and butyl (meth)acrylate.

According to certain embodiments, only one second alkyl (meth)acrylate comonomer is used to manufacture copolymer B.

According to other embodiments, copolymer B may be manufactured from more than one second alkyl (meth)acrylate comonomer, for example two or three second comonomers. For example, copolymer B may be manufactured from ethyl (meth)acrylate and/or methyl (meth)acrylate and/or butyl (meth)acrylate.

The units derived from the second comonomer(s) may have a molar content in copolymer B of from 5% to 35%, and preferably from 20% to 30%. This molar content may notably be from 5% to 10%; or from 10% to 15%; or from 15% to 20%; or from 20% to 25%; or from 25% to 30%; or from 30% to 35%.

The third comonomer includes at least one reactive function in the form of an acid, anhydride or epoxide group.

According to certain embodiments, the third comonomer is chosen from unsaturated carboxylic acids or carboxylic acid anhydride derivatives thereof, and preferably from unsaturated dicarboxylic acids or dicarboxylic acid anhydride derivatives thereof.

Examples of unsaturated dicarboxylic acid anhydrides are notably maleic anhydride, itaconic anhydride, citraconic anhydride, and tetrahydrophthalic anhydride. Maleic anhydride is preferably used.

Unsaturated monocarboxylic or dicarboxylic acid monomers such as (meth)acrylic acid may also be used.

Alternatively, the third comonomer may comprise an unsaturated epoxide type function.

Notable examples include:
aliphatic glycidyl esters and ethers, such as allyl glycidyl ether, vinyl glycidyl ether, glycidyl maleate and itaconate, glycidyl methacrylate (GMA) and acrylate; and
alicyclic glycidyl esters and ethers, such as glycidyl 2-cyclohex-1-ene ether, diglycidyl 4,5-cyclohexene carboxylate, glycidyl 4-cyclohexene carboxylate, glycidyl 5-norbornene-2-methyl-2-carboxylate and diglycidyl endocis-bicyclo[2.2.1]hept-5-ene-2,3-dicarboxylate.

The units derived from the third comonomer may be present in copolymer B in a molar content of from 0.1% to 15%, and preferably from 1% to 12%. This molar content may notably be from 0.1% to 1%; or from 1% to 3%; or from 3% to 5%; or from 5% to 7%; or from 7% to 9%; or from 9% to 11%; or from 11% to 13%; or from 13% to 15%.

According to certain embodiments, only one third alkyl (meth)acrylate comonomer is used to manufacture copolymer B.

According to other embodiments, copolymer B may comprise units derived from more than one third comonomer, for example two or three third comonomers. For example, the composition according to the invention may comprise units from maleic anhydride and from glycidyl methacrylate.

In such a case, the contents of units derived from the third comonomer are given relative to the total amount of the various third comonomers.

Preferably, copolymer B does not comprise any units derived from comonomers other than the first, second and third comonomers described above.

Preferably, copolymer B is a terpolymer, i.e. it includes units derived from only three comonomers.

Examples of preferred copolymers B are: terpolymers derived from ethylene, methyl acrylate and maleic anhydride; terpolymers derived from ethylene, ethyl acrylate and maleic anhydride; terpolymers derived from ethylene, butyl acrylate and maleic anhydride; terpolymers derived from ethylene, methyl acrylate and glycidyl methacrylate; terpolymers derived from ethylene, ethyl acrylate and glycidyl methacrylate; terpolymers derived from ethylene, butyl acrylate and glycidyl methacrylate.

Copolymer B is preferably manufactured by copolymerization of the various comonomers, notably of the high-pressure radical type. For example, the second and third comonomers may be copolymerized directly with ethylene, notably by high pressure radical polymerization.

According to certain preferred embodiments, the composition according to the invention, and more particularly copolymer B, is free of units derived from vinyl acetate. The reason for this is that said monomer may have toxic properties. Moreover, it is not suitable for hot extrusion, which makes it difficult or even impossible to form a film from a composition comprising units derived from this monomer.

As regards the additives, they are optionally present in a weight content of from 0 to 10% and preferably from 0 to 5%. For example, one or more additives may be present in a weight content of from 0 to 0.5%; or from 0.5% to 1%; or from 1% to 2%; or from 2% to 3%; or from 3% to 4%; or from 4% to 5%; or from 5% to 6%; or from 6% to 7%; or from 7% to 8%; or from 8% to 9%; or from 9% to 10%.

These additives may include, for example, inert dyes such as titanium dioxide, fillers, surfactants, crosslinking agents, nucleating agents, reactive compounds, mineral or organic flame retardants, ultraviolet (UV) or infrared (IR) light absorbers, and UV or IR fluorescent agents. Typical fillers include talc, calcium carbonate, clay, silica, mica, wollastonite, feldspar, aluminum silicate, alumina, hydrated alumina, glass microspheres, ceramic microspheres, thermoplastic microspheres, baryte, and wood flour.

These additives makes it possible to modify one or more physical properties of the composition.

Film

The invention also relates to a film obtained using the composition described above.

This film may preferably be manufactured by extrusion. Preferably, the extrusion is performed hot, at a temperature ranging from 100 to 300° C., preferably from 150 to 300° C., for example from 180 to 280° C.

According to certain embodiments, the film is manufactured by extrusion coating of the composition according to the invention onto a substrate. In this case, the extrusion temperature may be, for example, from 250 to 300° C. The substrate may be chosen from aluminum, paper, board, cellophane, films based on polyethylene, polypropylene, polyamide, polyester, polyvinyl chloride (PVC), polyvinylidene chloride (PVDC) or polyacrylonitrile (PAN) resins, these films being optionally oriented, optionally metallized, optionally treated by physical or chemical means, and films coated with a thin inorganic barrier layer, such as polyester (PET SiOx or AlOx) and woven or nonwoven fabrics. When the film is not a woven or nonwoven fabric, it is preferably perforated, notably micro-perforated.

According to other embodiments, the film may be manufactured by flat film extrusion (“extrusion casting”) of the composition according to the invention. In this case, the extrusion temperature may be, for example, from 180 to 230° C.

The film according to the invention is a waterproof-breathable film. The term “waterproof-breathable” means permeable to water vapor and impermeable to liquid water.

The film according to the invention may have a thickness of from 2 to 100 μm, preferably from 2 to 50 μm, or more preferably from 10 to 50 μm.

According to one embodiment, the waterproof-breathable film has a thickness of less than or equal to 50 mm, preferably less than or equal to 40 mm, 30 mm, or 25 mm, preferably between 5 and 25 mm.

A thickness as described above affords a good property in terms of permeability to water vapor.

Preferably, the film according to the invention has a permeability to water vapor (MVTR, for “Moisture Vapor Transmission Rate”) of at least 700 g/m2 per 24 hours, at 23° C., at a relative humidity of 50%, for a film thickness of 30 μm. More preferably, the permeability to water vapor MVTR of the film is at least 800 g/m²/24 h, at 23° C., at a relative humidity of 50%, for a film thickness of 30 μm. In particular, the MVTR membrane permeability may range from 700 to 800 g/m²/24 h, or from 800 to 900 g/m²/24 h, or from 900 to 1000 g/m²/24 h, or from 1000 to 1200 g/m²/24 h, or from 1200 to 1500 g/m²/24 h, or from 1500 to 2000 g/m²/24 h, or from 2000 to 2500 g/m²/24 h, or from 2500 to 3000 g/m²/24 h, or from 3000 to 3500 g/m²/24 h, or from 3500 to 4000 g/m²/24 h, or from 4000 to 4500 g/m²/24 h, or from 4500 to 5000 g/m²/24 h, at 23° C., at a relative humidity of 50%, for a film thickness of 30 μm. The permeability to water vapor (MVTR) of the film, at 23° C., for a relative humidity of 50%, for a film thickness of 30 μm, may be measured according to the standard ASTM E96 B.

The invention also relates to the use of a film as described in the present invention in the medical, hygiene, luggage, manufacturing, clothing, domestic or household equipment, furnishing, carpet, motor vehicle, industry, notably industrial filtration, agriculture and/or construction sector.

The invention also relates to a laminated product (hereinbelow a laminate) comprising at least one material and at least one waterproof-breathable film according to the invention, in which the material may be chosen, for example, from textile, a building material, packagings or coatings.

According to a particular embodiment, the material is a textile material, said film adhering to at least one surface of the textile material with a peel force that is within the range from 0.5 to 50 N, preferably from 0.5 to 10 N.

Advantageously, the film according to the invention is notably applied to a textile material via any known process, preferably without using an adhesive between the film and the textile.

Examples that may be mentioned include extrusion coating of a film of the composition onto the textile, or hot pressing (thermo-lamination or lamination bonding) of the film onto a textile or between two textiles, at a temperature that is sufficient for the film to impregnate and entrap the textile fibers.

According to an alternative embodiment or an embodiment combined with the preceding one(s), mention may also be made of bonding using an adhesive seal, preferably an aqueous adhesive seal, i.e. comprising less than 5% by weight of solvent on the adhesive seal composition.

Preferably, the film has a thickness of between 5 and 50 mm, and preferably between about 5 and 10 mm. Advantageously, in an extrusion-coating application, from 10 to 50 g/m² of thermoplastic film are applied to the textile.

In the present description of the invention, the following definitions apply:
the term “textile material” or “textile” means any material made from fibers or from filaments and also any material, including paper and cardboard, forming a porous membrane characterized by a length/thickness ratio of at least 300;
the term “fiber” means any synthetic or natural material characterized by a length/diameter ratio of at least 300;
the term “filament” means any fiber of infinite length.

Among the textiles are, notably, fiber laps (dressings, filters, felt), roving (dressings), yarns (for sewing, knitting or weaving), knitted fabrics (rectilinear, circular, fully-fashioned), fabrics (traditional, Jacquard, multiple, double-sided, multiaxial, 2.5D, 3D), and many others.

According to a preferred embodiment of the invention, said at least one textile material is in the form of a porous membrane, a woven textile or a nonwoven textile.

Advantageously, said at least one textile material comprises synthetic fibers, notably synthetic fibers obtained from biobased raw materials, natural fibers, artificial fibers manufactured from natural raw materials, mineral fibers and/or metallic fibers.

Advantageously, said textile comprises synthetic fibers obtained from biobased raw materials, such as polyamide fibers, notably polyamide 11. Advantageously, said textile also comprises natural fibers, such as cotton, wool and/or silk, artificial fibers manufactured from natural raw materials, and mineral fibers, such as carbon, glass, silica and/or magnesium fibers.

The textile is notably chosen from fabrics or textile surfaces, such as woven, knitted, nonwoven or carpet surfaces. These articles may be, for example, carpets, rugs, upholstery, surface coverings, sofas, curtains, bedding, mattresses and pillows, garments and medical textile materials.

The textile according to the invention advantageously constitutes a felt, a filter, a film, a gauze, a cloth, a dressing, a layer, a fabric, a knitted fabric, a clothing article, a garment, a bedding article, a furnishing article, a curtain, a passenger compartment covering, a functional technical textile, a geotextile and/or an agrotextile.

### EXAMPLE

The example that follows illustrates the invention without limiting it.

Films were prepared from different compositions (A to G) in the following two ways so as to evaluate the permeability to water vapor and the stability limit (processability) of the films.

For the evaluation of the permeability to water vapor:

The films were prepared from the various compositions (A to G) via a flat film extrusion process (“extrusion casting”) using an extruder having the following parameters:
screw diameter: 30 mm;
L/D ratio: 25
profile: screw-barrier;
die: T-shaped, 250 μm wide and 300 μm air gap.

The extrusion temperatures were between 180° C. and 230° C. and were adapted according to the grade of the copolymer.

The permeability to water vapor MVTR was measured at 23° C., at 50% relative humidity, according to the standard ASTM E96B.

The films obtained have a thickness of 50 μm.

For the evaluation of the processability:

The films were prepared from the various compositions (A to G) by extrusion coating on an aluminum (37 pm)/polymer support using a Collin extrusion coating line having the following parameters:
air gap: 70 mm;
screw speed: 80 rpm
die gap: 300 μm.

The extrusion temperature was 280° C.

The films have an initial thickness of 50 μm (which decreases with increasing line speed).

Thus, to evaluate the stability limit of the film, the line speed was gradually increased from 5 m/min until instability was observed. This instability may be breakage of the film, one or more holes formed on the film or instability of the film width. These observations were made three times so as to confirm the results, and an average value was taken.

The film stability limit corresponds to the speed at and above which instabilities appear.

In both cases:

The terpolymers (polymers comprising units derived from at least three comonomers) used are the following:

TABLE 1

| | | 2nd monomer | 3rd monomer |
|---|---|---|---|
| Terpolymer | 1st monomer | (molar content) | (molar content) |
| Terpo1 | Ethylene | Ethyl acrylate | Maleic anhydride |
| | | (29%) | (1.3%) |
| Terpo2 | Ethylene | Butyl acrylate | Glycidyl |
| | | (25%) | methacrylate |
| | | | (8%) |
| Terpo3 | Ethylene | Butyl acrylate | Glycidyl |
| | | (25%) | methacrylate |
| | | | (5%) |

The copolymers used for comparative purposes are the following:

TABLE 2

| | | 2nd monomer |
|---|---|---|
| Copolymer | 1st monomer | (molar content) |
| Copo1 | Ethylene | Ethyl acrylate (25%) |
| Copo2 | Ethylene | Butyl acrylate (30%) |

The features of compositions A to G are given in the following table:

TABLE 3

| | PEBA copolymer (%) | Terpolymer or |
|---|---|---|
| Compositions | PA 12/PEG (50/50) | copolymer (%) |
| A | 90% | Terpo1 (10%) |
| B | 90% | Terpo2 (10%) |
| C | 90% | Terpo3 (10%) |
| D | 80% | Terpo1 (20%) |
| E | 90% | Copo1 (10%) |
| F | 90% | Copo2 (10%) |
| G | 100% | — |

TABLE 4

| | PEBA copolymer (%) | Terpolymer or |
|---|---|---|
| Compositions | PA 12/PTMG (50/50) | copolymer (%) |
| H | 100% | |
| I | 90% | Terpo1 (10%) |

Compositions A to C are according to the invention and compositions D to I correspond to comparative examples (composition D comprises a copolymer B according to the invention but with a higher content than that claimed and composition G comprises only PEBA copolymer).

The results of the permeability to water vapor and also the stability limit of the films (A to I) obtained with compositions (A to I) are presented below:

TABLE 5

| | Stability | Permeability to |
|---|---|---|
| Films | limit (m/min) | water vapor |
| A (invention) | 35 | 845 |
| B (invention) | 40 | 855 |
| C (invention) | 37 | 850 |
| D (comparative) | 50 | 645 |
| E (comparative) | 25 | 850 |
| F (comparative) | 25 | 840 |
| G (comparative) | 15 | 950 |
| H | 20 | 300 |
| I | 40 | 300 |

It is observed that the films according to the invention (A to C) have both high permeability to water vapor and good processability (stability limit of the film).

1. A composition consisting of:
from 75% to 98% by weight of at least one copolymer A containing polyamide blocks and polyether blocks, relative to the weight of the composition;
from 2% to 15% by weight of at least one copolymer B comprising units derived from ethylene, from an alkyl (meth)acrylate and from a comonomer including at least one acid, anhydride or epoxide function, relative to the weight of the composition; and
from 0% to 10% by weight of at least one additive, relative to the weight of the composition,
in which the polyether blocks of copolymer A comprise polyethylene glycol blocks.

2. The composition as claimed in claim 1, in which the polyamide blocks of copolymer A are blocks of polyamide 11, or of polyamide 12, or of polyamide 6, or of polyamide 10.10, or of polyamide 10.12, or of polyamide 6.10, and also combinations thereof.

3. The composition as claimed in claim 1, in which the alkyl (meth)acrylate includes an alkyl group comprising from 1 to 24 carbon atoms.

4. The composition as claimed in claim 1, in which the alkyl (meth)acrylate is chosen from methyl (meth)acrylate, ethyl (meth)acrylate, and butyl (meth)acrylate and also combinations thereof.

5. The composition as claimed in claim 1, in which the molar content of units derived from alkyl (meth)acrylate in copolymer B is from 5% to 35%.

6. The composition as claimed in claim 1, in which the molar content of comonomer including at least one acid, anhydride or epoxide function in copolymer B is from 0.1% to 15%.

7. The composition as claimed in claim 1, in which the comonomer including at least one acid, anhydride or epoxide function is chosen from unsaturated carboxylic acid anhydrides.

8. The composition as claimed in claim 1, in which the comonomer including at least one acid, anhydride, or epoxide function has an unsaturated epoxide function.

9. The composition as claimed in claim 1, in which copolymer B is free of units derived from vinyl acetate.

10. The composition as claimed in claim 1, in which the additive is chosen from inert dyes, fillers, surfactants, crosslinking agents, nucleating agents, reactive compounds, mineral or organic flame retardants, ultraviolet (UV) or infrared (IR) light absorbers, UV or IR fluorescent agents, and also combinations thereof.

11. A process for manufacturing a film, comprising the extrusion of the composition as claimed in claim 1.

12. The process as claimed in claim 11, in which the extrusion is performed at a temperature of from 100 to 300° C.

13. The process as claimed in claim 11, in which the extrusion is extrusion coating or extrusion casting.

14. A film obtained via the process as claimed in claim 11.

15. An article of manufacture comprising the film as claimed in claim 14, in the medical, hygiene, luggage, manufacturing, clothing, domestic or household equipment, furnishing, carpet, motor vehicle, industry, notably industrial filtration, agriculture and/or construction sector.
